(19) United States
(12) Patent Application Publication
(10) Pub. No.: US 2024/0052988 A1
(43) Pub. Date: Feb. 15, 2024

(54) LENS UNIT AND VEHICLE LAMP

(71) Applicant: KOITO MANUFACTURING CO., LTD., Tokyo (JP)

(72) Inventor: Kazuma MOCHIZUKI, Shizuoka-shi, Shizuoka (JP)

(73) Assignee: KOITO MANUFACTURING CO., LTD., Tokyo (JP)

(21) Appl. No.: 18/267,199

(22) PCT Filed: Dec. 9, 2021
(86) PCT No.: PCT/JP2021/045421

§ 371 Date: Jun. 14, 2023

(30) Foreign Application Priority Data
Dec. 15, 2020 (JP) 2020-207829

(51) Int. Cl. F21S 41/29; F21S 41/255; F21S 41/265; F21S 41/40; F21S 41/153

(52) U.S. Cl. CPC F21S 41/295; F21S 41/255; F21S 41/265; F21S 41/40; F21S 41/153; F21Y 2115/10

(57) ABSTRACT

A lens unit (40) includes a plurality of lens members (60, 70, 80), and a lens holder (50) including a support portion (51) formed in a cylindrical shape having an opening (51h1) at one end through which each of the plurality of lens members (60, 70, 80) can be inserted. The support portion (51) supports the plurality of lens members (60, 70, 80) so as for the plurality of lens members to be arranged along a central axis (51a) of the support portion (51), and a communication portion (56) that lets an inside and an outside of the support portion (51) communicate with each other and exposes an outer peripheral portion (62, 72, 82) of at least one of the plurality of lens members (60, 70, 80) from the support portion (51) is formed on a side wall of the support portion (51).

### TECHNICAL FIELD

The present invention relates to a lens unit and a vehicle lamp.

### BACKGROUND ART

A lens unit including a plurality of lenses and a lens holder supporting the plurality of lenses is known, and for example, Patent Literature 1 below discloses a vehicle lamp including such a lens unit.

The lens unit in Patent Literature 1 below includes the plurality of lenses and the lens holder having a cylindrical support portion, and the support portion supports the plurality of lenses so as for the lenses to be arranged along the central axis of the support portion.
[Patent Literature 1] JP 2019-021602 A

### SUMMARY OF INVENTION

Therefore, in the assembly of the lens unit in Patent Literature 1, for example, it is considered that the plurality of lenses are sequentially inserted into the support portion from an opening at one end of the support portion to support these lenses on the support portion. In a state where the plurality of lenses are supported on the support portion, the entire outer peripheral portions of the plurality of lenses are surrounded by the support portion. For this reason, for example, when an attempt is made to insert the lens into the support portion while pinching and gripping the outer peripheral portion of the lens with a tool or a finger of an operator, the tool or the finger of the operator easily comes into contact with the support portion, and it is difficult to support the lens at a predetermined position in the support portion.

Therefore, an object of the present invention is to provide a lens unit and a vehicle lamp that can easily be assembled.

In order to achieve the above object, a lens unit according to the present invention includes a plurality of lens members each having a lens portion that changes a divergence angle of transmitted light, and a lens holder including a support portion formed in a cylindrical shape having an opening at one end through which each of the plurality of lens members can be inserted. The support portion supports the plurality of lens members so as for the plurality of lens members to be arranged along a central axis of the support portion, and a communication portion that lets an inside and an outside of the support portion communicate with each other and exposes an outer peripheral portion of at least one of the plurality of lens members from the support portion is formed on a side wall of the support portion.

In this lens unit, when the lens members exposed from the support portion through the communication portion are to be supported by the support portion, for example, the outer peripheral portions of the lens members can be moved by being pressed with a tool or a finger of an operator via the communication portion. Therefore, with this lens unit, the lens members can be easily supported at predetermined positions in the support portion as compared with a case where the communication portion is not formed, and the assembly can be facilitated.

At least two of the lens members may be exposed from the communication portion.

With such a configuration, for example, the relative positions of the at least two of the lens members exposed can be easily set at predetermined positions, and the assembly can further be facilitated.

In this case, a pair of the lens members adjacent to each other out of the at least two of the lens members may be provided with fitting portions to be fitted to each other, and, as viewed along a straight line that perpendicularly intersects with the central axis and passes through a center of the communication portion, the fitting portions may overlap with the communication portion and may be located further on a side provided with the communication portion than the central axis.

With such a configuration, as compared with a case where the fitting portions to be fitted to each other are not provided in the pair of the lens members adjacent to each other, it is possible to suppress relative positional misalignment between one lens member and the other lens member in the pair of the lens members. In addition, as described above, as viewed along the straight line that perpendicularly intersects with the central axis and passes through the center of the communication portion, the fitting portions overlap with the communication portion and are located further on the side provided with the communication portion than the central axis of the support portion. Therefore, with this lens unit, as viewed in this manner, the fitting portions can be easily visually recognized through the communication portion, and the fitting portions can be easily fitted to each other as compared with a case where the fitting portions do not overlap with the communication portion or a case where the fitting portions are located on the opposite side of the side provided with the communication portion with the central axis interposed between the sides.

The communication portion may be a slit extending from the one end toward another end of the support portion.

With such a configuration, for example, the tool for gripping the lens members or the finger of the operator is made to pass through the slit, so that the lens members can be inserted and moved from the opening at the one end into the support portion in a state where the lens members are gripped. Therefore, according to this lens unit, the assembly can further be facilitated.

The lens holder may further include a securing portion that extends from the support portion to a side opposite to a side provided with the central axis and is secured to another member, and a reinforcing plate that extends from the securing portion in a direction non-perpendicular to the central axis and is connected to an outer peripheral surface of the support portion, and the reinforcing plate may overlap with the communication portion in a circumferential direction of the support portion.

By forming the communication portion, the strength of the support portion tends to decrease as compared with a case where the communication portion is not formed. However, with such a configuration, it is possible to suppress the decrease in strength of the support portion as compared with a case where the reinforcing plate does not overlap with the communication portion in the circumferential direction of the support portion.

An outer peripheral surface of at least one of the plurality of lens members may have a region where a predetermined uneven pattern is formed, and the region may be exposed from the communication portion.

With such a configuration, a part of light incident on the lens portion of the lens member having the above-described region can be emitted from the region and can be emitted to the outside of the support portion via the communication portion. As described above, the predetermined uneven pattern is formed in the predetermined region. Thus, by adjusting the uneven pattern, the emission direction and the diffusion state of the light emitted through the communication portion can be adjusted, and for example, the aesthetic impression can be improved.

The communication portion may be formed on each of both sides in a predetermined direction with the central axis interposed therebetween.

With such a configuration, when the lens members exposed from the communication portions are to be supported by the support portion, for example, the tool or the finger of the operator is inserted into each of the communication portions, so that the lens members can be pinched, gripped, and moved in the width direction. Therefore, according to this lens unit, the assembly can further be facilitated. From the viewpoint of easily gripping the lens members, the above-described region is preferably exposed from the communication portions. Since the predetermined uneven pattern is formed in this region, the lens members can be easily gripped as compared with a case where this region is not provided.

In this case, a shape of a specific lens member out of the plurality of lens members as viewed along the central axis may be long in the predetermined direction, and each of the communication portions may expose the specific lens member from the support portion.

With such a configuration, for example, the specific lens member can be pinched and gripped in the longer direction with the tool or the finger of the operator. In the case of pinching the lens members in the longer direction, the lens members can be made less likely to be inclined in the thickness direction as compared with the case of pinching the lens members in the shorter direction. Therefore, with this lens unit, the specific lens member can be easily moved in the support portion as compared with a case where the specific lens member is short in length in the predetermined direction.

The lens unit may further include a shielding portion that covers the communication portion from an outside of the support portion in a state of being attached to the support portion.

With such a configuration, as compared with a case where the shielding portion is not provided, it is possible to restrict dirt, dust, and the like from entering the support portion via the communication portions.

In this case, the support portion and the shielding portion may have a light shielding property.

With such a configuration, it is possible to restrict a part of the light incident on the lens portions of the lens members from leaking to the outside of the support portion via the communication portions.

In this case, the shielding portion may cover at least a part of an edge portion along an edge of the communication portion in the support portion.

With such a configuration, as compared with a case where the shielding portion does not cover the edge portion, it is possible to further restrict a part of the light incident on the lens portions of the lens members from leaking to the outside of the support portion.

Also, a vehicle lamp according to the present invention includes the lens unit, and a light source unit that emits light transmitted through the plurality of lens members in an arrangement order of the lens members.

As described above, according to the present invention, a lens unit and a vehicle lamp that can easily be assembled are provided.

### BRIEF DESCRIPTION OF DRAWINGS

FIG. 1 is a side view schematically illustrating a vehicle lamp including a lens unit according to an embodiment of the present invention.

FIG. 2 is a perspective view schematically illustrating a lamp unit illustrated in FIG. 1.

FIG. 3 is an exploded perspective view schematically illustrating the lamp unit.

FIG. 4 is a horizontal cross-sectional view schematically illustrating the lamp unit.

FIG. 5 is a front view schematically illustrating a lens holder.

FIG. 6 is a rear view schematically illustrating a first lens member.

FIG. 7 is a rear view schematically illustrating a second lens member.

FIG. 8 is a view illustrating a state in which lens members are supported by a support portion.

### DESCRIPTION OF EMBODIMENTS

Hereinbelow, a preferred embodiment of a lens unit and a vehicle lamp according to the present invention will be described in detail with reference to the drawings. The embodiment exemplified below is intended to facilitate understanding of the present invention and is not intended to limit the present invention. The present invention can be modified and improved without departing from the gist thereof. In the drawings referred to below, dimensions of each member may be changed to facilitate understanding.

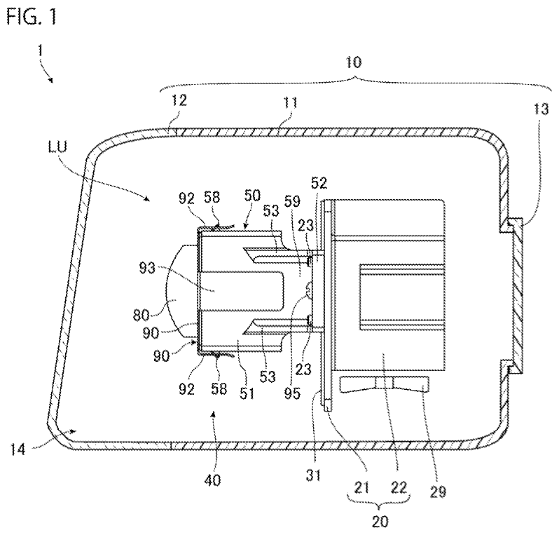

FIG. 1 is a side view schematically illustrating a vehicle lamp including a lens unit according to an embodiment of the present invention. A vehicle lamp 1 according to the present embodiment is an automobile headlight. The automobile headlight is generally provided in each of the right and left sides of the front of the vehicle, and the right and left headlights have a substantially symmetrical configuration in the right-left direction. Therefore, in the present embodiment, one of the headlights will be described. As illustrated in FIG. 1, the vehicle lamp 1 according to the present embodiment includes a housing 10 and a lamp unit LU as main components. In FIG. 1, the housing 10 is illustrated in a vertical cross section.

The housing 10 according to the present embodiment includes a lamp housing 11, a front cover 12, and a back cover 13 as main components. The front of the lamp housing 11 is opened, and the front cover 12 is secured to the lamp housing 11 so as to close the opening. Also, a smaller opening than one at the front is formed at the rear of the lamp housing 11, and the back cover 13 is secured to the lamp housing 11 so as to close the opening. In the housing 10, a storage space 14 surrounded by the lamp housing 11, the front cover 12, and the back cover 13 is formed, and the lamp unit LU is arranged in the storage space 14.

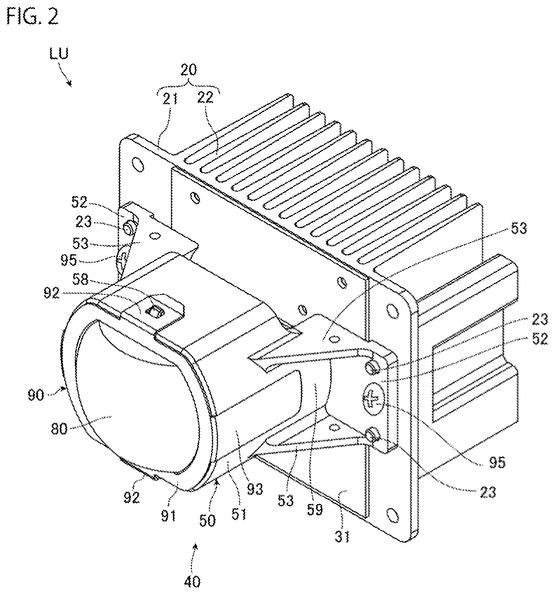

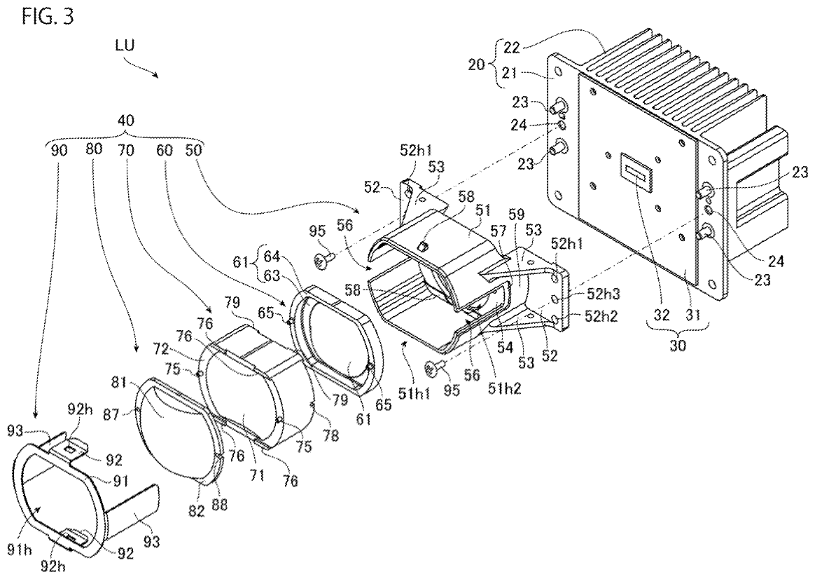

FIG. 2 is a perspective view schematically illustrating the lamp unit LU, and is a perspective view of the lamp unit LU viewed diagonally from the upper front. FIG. 3 is an exploded perspective view schematically illustrating the lamp unit LU, and is an exploded perspective view of the lamp unit LU viewed diagonally from the upper front. FIG. 4 is a horizontal cross-sectional view schematically illustrating the lamp unit LU illustrated in FIG. 1. As illustrated in FIGS. 1 to 4, the lamp unit LU according to the present embodiment mainly includes a heat sink 20, a cooling fan 29, a light source unit 30, and a lens unit 40. Note that, in FIG. 3, description of the cooling fan 29 is omitted, and in FIG. 4, description of a part of the heat sink 20 is omitted.

The heat sink 20 according to the present embodiment includes a base plate 21 made of metal extending substantially in the vertical direction and in the right-left direction, and on the rear surface side of the base plate 21, a plurality of heat dissipation fins 22 are provided integrally with the base plate 21. At each of the right and left end portions of the base plate 21, two bosses 23 protruding to the front side and a screw hole 24 are provided. The two bosses 23 and the screw hole 24 are arranged in the up-down direction such that the screw hole 24 is interposed between the two bosses 23. The cooling fan 29 is disposed to be spaced from the heat dissipation fin 22 and is secured to the heat sink. The heat sink 20 is cooled by the airflow generated by the rotation of the cooling fan 29.

The light source unit 30 according to the present embodiment includes a circuit board 31 and a light emitting unit 32. The circuit board 31 is provided on the front surface of the base plate 21 in the heat sink 20. The light emitting unit 32 is implemented on the circuit board 31 and emits light to the front side by being supplied with power from the circuit board 31. In the present embodiment, the light emitting unit 32 is a so-called LED array in which a plurality of light emitting diodes (LEDs) are arranged in a matrix form. Therefore, the light source unit 30 can emit light of a predetermined light distribution pattern by selecting the LEDs from which light is emitted. Also, the light source unit 30 can adjust the intensity distribution of light in the predetermined light distribution pattern by adjusting the intensity of light emitted from the respective LEDs. Note that the light source unit 30 is not particularly limited as long as it can emit light.

The lens unit 40 includes a plurality of lens members, and adjusts a divergence angle of incident light by means of the plurality of lens members. In the present embodiment, the lens unit 40 includes a lens holder 50, a first lens member 60, a second lens member 70, a third lens member 80, and a cover 90, and the three lens members 60, 70, and 80 are supported by the lens holder 50.

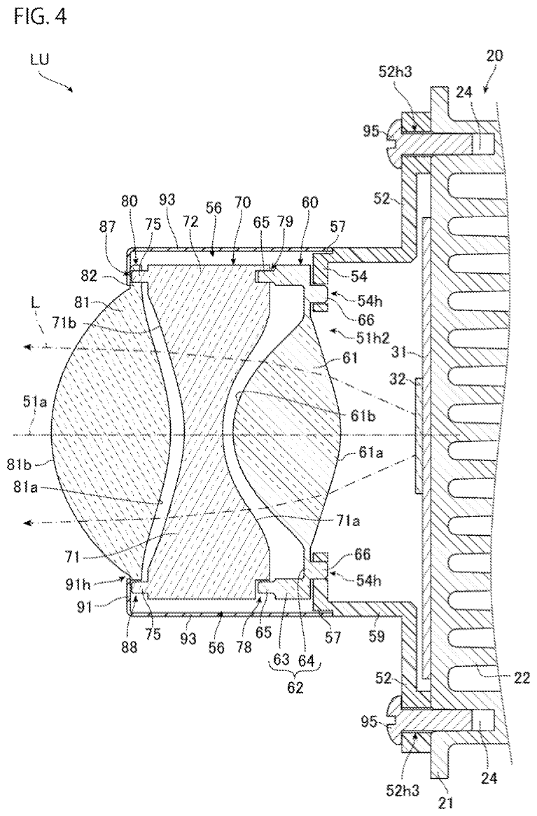

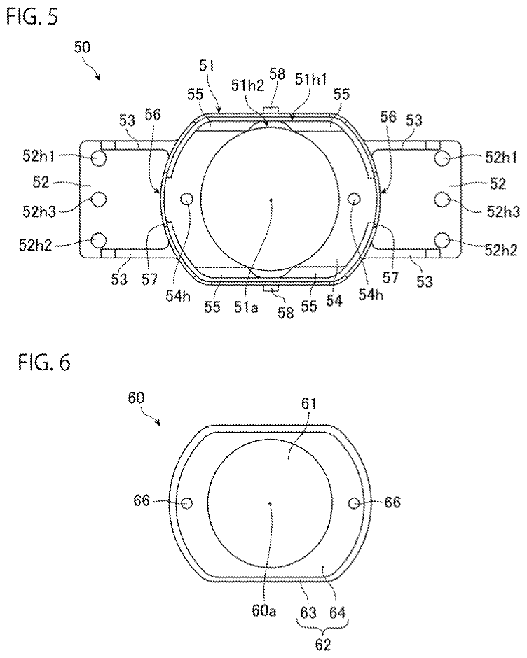

FIG. 5 is a front view schematically illustrating the lens holder 50, and is a view of the lens holder 50 viewed from the front side. As illustrated in FIGS. 3 to 5, the lens holder 50 according to the present embodiment includes a cylindrical support portion 51 extending in the front-rear direction, a pair of right and left plate-shaped securing portions 52, and four reinforcing plates 53. The lens holder 50 has a light shielding property, and is made of, for example, resin, and the support portion 51, the securing portions 52, and the reinforcing plates 53 are integrally formed.

In the present embodiment, the outer shape of the support portion 51 as viewed along a central axis 51a of the support portion 51 is a substantially oval track shape in which a pair of short sides of a rectangle that is long in the right-left direction, which is a predetermined direction perpendicular to the central axis 51a, is in an arc shape curved outward. Of the side walls constituting the support portion 51, the upper side and the lower side extend substantially in the horizontal direction, and the right side and the left side are curved substantially in the arc shape. An opening 51h1 at the front end of the support portion 51 is substantially in an oval track shape that is substantially similar in shape to the outer shape of the support portion 51 and is long in the right-left direction. Note that the shape of the support portion 51 is not particularly limited, and for example, the support portion 51 may be in a cylindrical shape.

At the rear end portion of the support portion 51 is provided a support wall 54 protruding substantially perpendicularly from the inner peripheral surface. The support wall 54 extends over the entire circumference of the inner peripheral surface, and an opening 51h2 at the rear end of the support portion 51 is defined by the tip end of the support wall 54. In the present embodiment, the shape of the opening 51h2 is substantially circular, but the shape of the opening 51h2 is not particularly limited. The support wall 54 is provided with a plurality of abutting portions 55 protruding from the front surface to the front side so as to surround the opening 51h2, and the end surfaces of the abutting portions 55 substantially coincide with a predetermined plane perpendicular to the central axis 51a. Also, through holes 54h are formed on both the right and left sides of the support wall 54. Such a support portion 51 supports the three lens members 60, 70, and 80 so as for the lens members to be arranged along the central axis 51a.

On both the sides of the side wall of the support portion 51 in a predetermined direction with the central axis 51a interposed therebetween, communication portions 56 penetrating from the inner peripheral surface to the outer peripheral surface to let the inside and the outside of the support portion 51 communicate with each other are formed. In the present embodiment, the predetermined direction is the right-left direction, which is a direction perpendicular to the central axis 51a, and the communication portions 56 are formed at portions curved in the arc shape that are both the sides of the side wall of the support portion 51 in the right-left direction, which is the predetermined direction. In the present embodiment, the communication portion 56 is a slit extending from the front end toward the rear end of the support portion 51, and the rear end of the communication portion 56 coincides with the front surface of the support wall 54. The two communication portions 56 overlap with each other in the radial direction of the support portion 51. On the outer peripheral surface of the support portion 51 is formed a groove 57 extending along the edge of the communication portion 56, and the groove 57 surrounds the entire edge of the communication portion 56. Note that the communication portion 56 has only to penetrate from the inner peripheral surface to the outer peripheral surface to let the inside and the outside of the support portion 51 communicate with each other, and may be, for example, a through hole penetrating from the inner peripheral surface to the outer peripheral surface.

On both the upper and lower sides, formed substantially in a flat plate shape, of the side wall of the support portion 51 are formed protrusions 58 protruding from the outer peripheral surface. Also, on each of the right and left sides of the rear end of the support portion 51 is formed a connecting portion 59 extending to the rear side, and the outer surface of the connecting portion 59 is an arc-shaped surface connected to the outer peripheral surface of the support portion 51.

The pair of right and left securing portions 52 is a member secured to the heat sink 20. In the present embodiment, the right securing portion 52 is a plate-shaped member extending from the rear end portion of the right connecting portion 59 in the right direction opposite to the side provided with the central axis 51a, and the left securing portion 52 is a plate-shaped member extending from the rear end portion of the left connecting portion 59 in the left direction opposite to the side provided with the central axis 51a. Each of the securing portions 52 is substantially perpendicular to the central axis 51a. In each of the securing portions 52, three through holes 52h1, 52h2, and 52h3 arranged in the up-down direction are formed. The upper and lower through holes 52h1 and 52h2 in the right securing portion 52 are formed at positions corresponding to the bosses 23 formed at the right end portion of the base plate 21 in the heat sink 20. The center through hole 52h3 of the right securing portion 52 is formed at a position corresponding to the screw hole 24 formed at the right end portion of the base plate 21. The upper and lower through holes 52h1 and 52h2 in the left securing portion 52 are formed at positions corresponding to the bosses 23 formed at the left end portion of the base plate 21. The center through hole 52h3 of the right securing portion 52 is formed at a position corresponding to the screw hole 24 formed at the left end portion of the base plate 21.

The reinforcing plate 53 is a plate-like member extending from the securing portion 52 in a direction non-perpendicular to the central axis 51a and connected to the outer peripheral surface of the support portion 51. In the present embodiment, two reinforcing plates 53 extend from the right securing portion 52, and two reinforcing plates 53 extend from the left securing portion 52. These reinforcing plates 53 extend in the right-left direction, which is a direction substantially parallel to the central axis 51a, and are substantially in triangular shapes. One side of the reinforcing plate 53 is connected to the front surface of the securing portion 52, and the other side is connected to the outer peripheral surface of the support portion 51. The two reinforcing plates 53 extending from the right securing portion 52 overlap with the right communication portion 56 in the circumferential direction of the support portion 51. Since the support portion 51 has the communication portion 56, the strength of the support portion 51 tends to decrease as compared with a case where the support portion 51 does not have the communication portion 56. However, in the present embodiment, the reinforcing plate 53 can suppress the decrease in strength of the support portion 51 having the communication portion 56. In addition, it is possible to suppress the decrease in strength of the support portion 51 as compared with a case where the reinforcing plate 53 does not overlap with the right communication portion 56 in the circumferential direction of the support portion 51. In the present embodiment, a part of the right communication portion 56 is located between the two reinforcing plates 53, and the two reinforcing plates 53 causes a part of the communication portion 56 to be interposed therebetween. Therefore, it is possible to suppress the decrease in strength of the support portion 51 as compared with a case where the two reinforcing plates 53 do not cause the communication portion 56 to be interposed therebetween. Note that, from the viewpoint of suppressing the decrease in strength of the support portion 51, the reinforcing plate 53 connected to the securing portion 52 and the support portion 51 has only to overlap with the communication portion 56 in the circumferential direction of the support portion 51. For example, one of the two reinforcing plates 53 may be omitted. Also, the two reinforcing plates 53 has only to extend in the direction non-perpendicular to the central axis 51a, and may be inclined with respect to the central axis 51a. Also, the two reinforcing plates 53 extending from the left securing portion 52 overlap with the left communication portion 56 in the circumferential direction of the support portion 51. Therefore, similarly to the case of the right reinforcing plate 53, it is possible to suppress the decrease in strength of the support portion 51.

As illustrated in FIGS. 3 and 4, the first lens member 60 according to the present embodiment includes a lens portion 61 that changes a divergence angle of transmitted light, and an outer peripheral portion 62 connected to the entire outer periphery of the lens portion 61. The first lens member 60 is made of, for example, resin or glass, and the lens portion 61 and the outer peripheral portion 62 are integrally formed. In the present embodiment, the lens portion 61 is a convex lens having a substantially circular outer shape, and one surface 61a and the other surface 61b are convexly curved. The outer peripheral portion 62 includes a cylindrical wall 63 having a cylindrical shape and a connection plate 64. The cylindrical wall 63 extends in the thickness direction of the lens portion 61 and surrounds the outer periphery of the lens portion 61. The connection plate 64 extends outward from the entire circumference of the outer peripheral surface of the lens portion 61, and connects the entire circumference of the outer peripheral surface of the lens portion 61 to the entire circumference of the inner peripheral surface of the cylindrical wall 63.

Such a first lens member 60 can be inserted through the opening 51h2 of the support portion 51. In the present embodiment, the outer shape of the first lens member 60 as viewed along the central axis of the first lens member 60 is substantially similar to that of the opening 51h1 of the support portion 51, and the first lens member 60 is slightly smaller than the opening 51h1. Note that the outer shape of the first lens member 60 is not particularly limited. In addition, two protrusions 65 as fitting portions are formed on the end surface of the cylindrical wall 63 on the side of the lens portion 61 provided with the other surface 61b. One of the protrusions 65 is located on one side of the first lens member 60 in the longer direction, and the other of the protrusions 65 is located on the other side of the first lens member 60 in the longer direction. In the present embodiment, the two protrusions 65 intersect with a plane including the central axis of the first lens member 60 and extending in the longer direction of the first lens member 60.

FIG. 6 is a rear view schematically illustrating the first lens member 60, and is a view of the first lens member 60 viewed from the side of the lens portion 61 provided with the one surface 61a. FIG. 6 illustrates a central axis 60a of the first lens member 60. As illustrated in FIG. 6, two protrusions 66 are formed on the surface of the connection plate 64 on the side of the lens portion 61 provided with the one surface 61a. One of the protrusions 66 is located on one side of the first lens member 60 in the longer direction and corresponds to one of the through holes 54h formed in the support wall 54 described above. The other protrusion 66 is located on the other side of the first lens member 60 in the longer direction and corresponds to the other of the through holes 54h formed in the support wall 54.

A predetermined uneven pattern is formed on the entire outer peripheral surface of the cylindrical wall 63, which is the outer peripheral surface of the first lens member 60. Examples of the predetermined uneven pattern include stripe-shaped grooves, grid-shaped grooves, an uneven pattern formed by embossing, an uneven pattern formed by sandblasting, and the like. The depth of the recess and the height of the protrusion in the uneven pattern are not particularly limited, and can be set to, for example, about 10 μm to 1 mm. Note that no predetermined uneven pattern may be formed on the outer peripheral surface of the cylindrical wall 63.

As illustrated in FIGS. 3 and 4, the second lens member 70 according to the present embodiment includes a lens portion 71 that changes a divergence angle of transmitted light, and an outer peripheral portion 72 connected to the entire outer periphery of the lens portion 71. The second lens member 70 is made of, for example, resin or glass, and the lens portion 71 and the outer peripheral portion 72 are integrally formed. In the present embodiment, the lens portion 71 is a concave lens having a substantially oval track shape whose outer shape is long in a predetermined direction, and one surface 71a and the other surface 71b are concavely curved. The outer peripheral portion 72 is a cylindrical member in which the entire circumference of the inner peripheral surface thereof is connected to the entire circumference of the outer peripheral surface of the lens portion 71.

Such a second lens member 70 can be inserted through the opening 51h2 of the support portion 51. In the present embodiment, the outer shape of the second lens member 70 as viewed along the central axis of the second lens member 70 is substantially similar to that of the opening 51h2 of the support portion 51, and the second lens member 70 is slightly smaller than the opening 51h1, similarly to the first lens member 60. Note that the outer shape of the second lens member 70 is not particularly limited. In addition, two protrusions 75 as fitting portions and four protrusions 76 as abutting portions are formed on the end surface of the outer peripheral portion 72 on the side of the lens portion 71 provided with the other surface 61b. One of the protrusions 75 is located on one side of the second lens member 70 in the longer direction, and the other of the protrusions 75 is located on the other side of the second lens member 70 in the longer direction. Further, two of the protrusions 76 are located on one side of the second lens member 70 in the shorter direction, and the other two of the protrusions 76 are located on the other side of the second lens member 70 in the shorter direction. In the present embodiment, the two protrusions 65 intersect with a plane including the central axis of the second lens member 70 and extending in the longer direction of the second lens member 70.

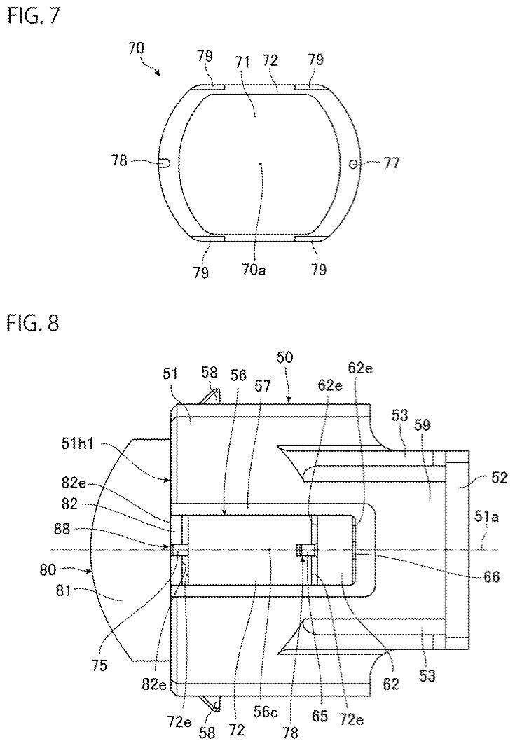

FIG. 7 is a rear view schematically illustrating the second lens member 70, and is a view of the second lens member 70 viewed from the side of the lens portion 71 provided with the one surface 71a. As illustrated in FIG. 7, a hole 77 and a groove 78 as fitting portions and four protrusions 79 as abutting portions are formed on the end surface of the outer peripheral portion 72 on the side of the lens portion 71 provided with the one surface 71a. The hole 77 is located on one side of the second lens member 70 in the longer direction and corresponds to the one protrusion 65 as the fitting portion of the first lens member 60. The groove 78 is located on the other side of the second lens member 70 in the longer direction, extends by a predetermined length inward from the outer edge of the outer peripheral portion 72, and corresponds to the other protrusion 65 as the fitting portion of the first lens member 60. Two of the protrusions 79 are located on one side of the second lens member 70 in the shorter direction, and the other two of the protrusions 79 are located on the other side of the second lens member 70 in the shorter direction. In the present embodiment, the four protrusions 79 and the four protrusions 76 correspond one-to-one, and the protrusions 79 overlap with the corresponding protrusions 76 as viewed along a central axis 70a of the second lens member 70. In addition, the hole 77 and the groove 78 intersect with a plane including the central axis 70a of the second lens member 70 and extending in the longer direction of the second lens member 70.

Similarly to the first lens member 60, a predetermined uneven pattern is formed on the entire outer peripheral surface of the outer peripheral portion 72, which is the outer peripheral surface of the second lens member 70. An example of the predetermined uneven pattern includes an uneven pattern similar to that of the first lens member 60. Note that no predetermined uneven pattern may be formed on the outer peripheral surface of the outer peripheral portion 72.

As illustrated in FIGS. 3 and 4, the third lens member 80 according to the present embodiment includes a lens portion 81 that changes a divergence angle of transmitted light, and an outer peripheral portion 82 connected to the entire outer periphery of the lens portion 81. The third lens member 80 is formed of, for example, resin or glass, and the lens portion 81 and the outer peripheral portion 82 are integrally formed. In the present embodiment, the lens portion 81 is a convex lens having a substantially oval track shape whose outer shape is long in a predetermined direction, and one surface 81a and the other surface 81b are convexly curved. The outer peripheral portion 82 is a flange protruding outward from the entire circumference of the outer peripheral surface of the lens portion 71.

Such a third lens member 80 can be inserted through the opening 51h2 of the support portion 51. In the present embodiment, the outer shape of the third lens member 80 as viewed along the central axis of the third lens member 80 is substantially similar to that of the opening 51h2 of the support portion 51, and the third lens member 80 is slightly smaller than the opening 51h1, similarly to the first lens member 60. Note that the outer shape of third lens member 80 is not particularly limited. A hole 87 and a slit 88 are formed as fitting portions in the outer peripheral portion 82. The hole 87 is located on one side of the third lens member 80 in the longer direction and corresponds to the one protrusion 75 as the fitting portion of the second lens member 70. The slit 88 is located on the other side of the third lens member 80 in the longer direction, extends by a predetermined length inward from the outer edge of the outer peripheral portion 82, and corresponds to the other protrusion 75 as the fitting portion of the second lens member 70.

Similarly to the first lens member 60, a predetermined uneven pattern is formed on the entire outer peripheral surface of the outer peripheral portion 82, which is the outer peripheral surface of the third lens member 80. An example of the predetermined uneven pattern includes an uneven pattern similar to that of the first lens member 60. Note that no predetermined uneven pattern may be formed on the outer peripheral surface of the outer peripheral portion 82.

The first lens member 60, the second lens member 70, and the third lens member 80 are inserted into the support portion 51 through the opening 51h2 of the support portion 51 of the lens holder 50 in this order, and are supported by the support portion 51. Specifically, the first lens member 60 is inserted into the support portion 51 from the opening 51h1 in a state where the longer direction is the right-left direction and the central axis 60a substantially coincides with the central axis 51a of the support portion 51. Then, the first lens member 60 is moved to the side provided with the support wall 54 of the lens holder 50, and as illustrated in FIG. 4, the protrusions 66 are fitted into the through holes 54h formed in the support wall 54, and the end surface of the cylindrical wall 63 is brought into contact with the abutting portions 55 formed in the support wall 54.

Subsequently, the second lens member 70 is inserted into the support portion 51 from the opening 51h1 in a state where the longer direction is the right-left direction and the central axis 70a substantially coincides with the central axis 51a of the support portion 51. The second lens member 70 is moved to the side provided with the first lens member 60, the one protrusion 66 of the first lens member 60 is fitted into the hole 77 of the second lens member 70, the other protrusion 66 is fitted into the groove 78 of the second lens member 70, and the protrusions 79 as the abutting portions of the second lens member 70 are brought into contact with the end surface of the cylindrical wall 63.

Subsequently, the third lens member 80 is inserted into the support portion 51 from the opening 51h1 in a state where the longer direction is the right-left direction and the central axis substantially coincides with the central axis 51a of the support portion 51. The one protrusion 75 of the second lens member 70 is fitted into the hole 87 of the third lens member 80, the other protrusion 75 is fitted into the slit 88 of the third lens member 80, and the outer peripheral portion 82 of the third lens member 80 is brought into contact with the protrusions 75 as abutting portions.

In a state where the lens members 60, 70, and 80 are inserted into the support portion 51 in this manner, the lens members 60, 70, and 80 are arranged along the central axis 51a of the support portion 51. That is, the support portion 51 supports the lens members 60, 70, and 80 so as for the lens members to be arranged along the central axis 51a. In the present embodiment, in a state where the lens members 60, 70, and 80 are supported by the support portion 51 in this manner, the central axis of each of the lens members 60, 70, and 80 substantially coincides with the central axis 51a. The one surface 61a of the lens portion 61 of the first lens member 60 crosses the opening 51h2. The other surface 61b of the lens portion 61 of the first lens member 60 is opposed to the one surface 71a of the lens portion 71 of the second lens member 70, and the other surface 71b of the lens portion 71 of the second lens member 70 is opposed to the one surface 81a of the lens portion 81 of the third lens member 80. The other surface 81b of the lens portion 81 of the third lens member 80 is located outside the support portion 51.

FIG. 8 is a view illustrating a state in which the lens members 60, 70, and 80 are supported by the support portion 51, and is a view taken along a straight line that perpendicularly intersects with the central axis 51a of the support portion 51 and passes through a center 56c of the left communication portion 56. As illustrated in FIG. 8, in the present embodiment, the left communication portion 56 of the support portion 51 exposes the lens members 60, 70, and 80 from the support portion 51. Also, although not illustrated, the right communication portion 56 exposes the lens members 60, 70, and 80 from the support portion 51 similarly to the left communication portion 56. Also, as viewed along the straight line that perpendicularly intersects with the central axis 51a and passes through the center 56c of the left communication portion 56, the hole 77 as a fitting portion, the other protrusion 65 as a fitting portion to be fitted into the hole 77, the hole 87 as a fitting portion, and the other protrusion 75 as a fitting portion to be fitted into the hole 87 overlap with the left communication portion 56. The hole 77, the other protrusion 65, the hole 87, and the other protrusion 75 are located on the side provided with the communication portion 56 on the right side of the central axis 51a. The lens members 60, 70, and 80 supported by the support portion 51 are restricted from coming off of the opening 51h1 by the cover 90.

The cover 90 according to the present embodiment covers a part of the opening 51h1 of the support portion 51 in a state of being attached to the support portion 51. As illustrated in FIGS. 1 to 4, the cover 90 according to the present embodiment has elasticity and includes a base portion 91, a pair of securing portions 92, and a pair of shielding portions 93. In the present embodiment, the base portion 91, the pair of securing portions 92, and the pair of shielding portions 93 are integrally formed by bending a metal plate, and have a light shielding property. Note that the material constituting the cover 90 is not particularly limited. For example, the cover 90 may be made of resin.

In the present embodiment, the base portion 91 is a plate-like member having a substantially similar shape to the outer shape of the support portion 51, and a through hole 91h is formed in the base portion 91. The pair of securing portions 92 and the pair of shielding portions 93 are plate-shaped members extending in a direction substantially perpendicular to the base portion 91 on one side with respect to the base portion 91. Through holes 92h are formed in the pair of securing portions 92. An end portion of one of the securing portions 92 on the side provided with the base portion 91 is connected to a portion of the outer edge portion of the base portion 91 extending substantially linearly on one side of the base portion 91 in the shorter direction. An end portion of the other of the securing portions 92 on the side provided with the base portion 91 is connected to a portion of the outer edge portion of the base portion 91 extending substantially linearly on the other side of the base portion 91 in the shorter direction. An end portion of one of the shielding portions 93 on the side provided with the base portion 91 is connected to a portion the outer edge portion of the base portion 91 extending in a substantially arc shape on one side of the base portion 91 in the longer direction. An end portion of the other of the shielding portions 93 on the side provided with the base portion 91 is connected to a portion the outer edge portion of the base portion 91 extending in a substantially arc shape on the other side of the base portion 91 in the longer direction.

The cover 90 is attached to the support portion 51 by fitting the protrusions 58 of the support portion 51 into the through holes 92h of the securing portion 92. In a state where the cover 90 is attached to the support portion 51, the base portion 91 covers the outer peripheral side of the opening 51h1, and the base portion 91 and the outer peripheral portion 82 of the third lens member 80 overlap with each other in a direction parallel to the central axis 51a. Therefore, the lens members 60, 70, and 80 are restricted from coming off of the opening 51h1. Further, the base portion 91 presses the outer peripheral portion 82 of the third lens member 80 toward the side provided with the support wall 54 of the support portion 51, and the lens members 60, 70, and 80 are held so as to be interposed between the base portion 91 and the support wall 54. Although not illustrated, each of the straight lines parallel to the central axis 51a of the support portion 51 and passing through the protrusion 79 of the second lens member 70 passes through the base portion 91, the outer peripheral portion 82 of the third lens member 80, the protrusion 76 of the second lens member 70, the 63 of the first lens member 60, and the abutting portion 55 of the support wall 54. Therefore, when the lens members 60, 70, and 80 are held so as to be interposed between the base portion 91 and the support wall 54, the lens members 60, 70, and 80 are restricted from being inclined with respect to the central axis 51a.

In addition, in a state where the cover 90 is attached to the support portion 51, the one shielding portion 93 covers the one communication portion 56 from the outside of the support portion 51, and the other shielding portion 93 covers the other communication portion 56 from the outside of the support portion 51. Therefore, as compared with a case where the cover 90 does not have the shielding portions 93, it is possible to restrict dirt, dust, and the like from entering the support portion 51 via the communication portions 56. In addition, in a state where the cover 90 is attached to the support portion 51, each of the shielding portions 93 is inserted into the groove 57 of the support portion 51. Therefore, the shielding portions 93 are restricted from protruding from the outer peripheral surface of the support portion 51. In addition, each of the shielding portions 93 covers the entire edge portion along the edge of the communication portion 56 in the support portion 51.

As illustrated in FIGS. 2 and 3, such a lens unit 40 is placed on the front surface of the base plate 21 such that the bosses 23 and 23 of the heat sink 20 are inserted into the through holes 52h1 and 52h2 of the right and left securing portions 52, and screws 95 are inserted into the through holes 52h2 of the securing portions 52 and fastened to the screw holes 24, thereby being secured to the heat sink 20. As illustrated in FIG. 4, in a state where the lens unit 40 is secured to the heat sink 20, the central axis 51a of the support portion 51 passes through the light emitting unit 32 of the light source unit 30. That is, the lens holder 50 is formed such that the central axis 51a passes through the light emitting unit 32. Then, light L emitted from the light source unit 30 is transmitted through the lens portions 61, 71, and 81 of the lens members 60, 70, and 80 in the order of the first lens member 60, the second lens member 70, and the third lens member 80, and the divergence angle of the light L is adjusted. The light L whose divergence angle is adjusted by the lens members 60, 70, and 80 is emitted from the vehicle lamp 1 toward the front of the vehicle via the front cover 12. In the present embodiment, the shapes of the lens portions 61, 71, and 81 in the lens members 60, 70, and 80 are adjusted such that the light distribution pattern of the light L emitted from the light source unit 30 is projected to be a predetermined light distribution pattern of a predetermined size on a virtual plane spaced a predetermined distance ahead of the vehicle.

As described above, the lens unit 40 according to the present embodiment includes the plurality of lens members 60, 70, and 80 having the lens portions 61, 71, and 81 that change the divergence angle of transmitted light, and the lens holder 50. The lens holder 50 has the cylindrical support portion 51 in which each of the plurality of lens members 60, 70, and 80 can be inserted into the opening 51h2 at the front end. The support portion 51 supports the plurality of lens members 60, 70, and 80 so as for the lens members to be arranged along the central axis 51a of the support portion 51. On the side walls of the support portion 51, the communication portions 56 that let the inside and the outside of the support portion 51 communicate with each other and expose the outer peripheral portions 62, 72, and 82 of the lens members 60, 70, and 80 from the support portion 51 are formed. Therefore, in the lens unit 40 according to the present embodiment, when the lens members 60, 70, and 80 exposed from the communication portions 56 are to be supported by the support portion 51, for example, the outer peripheral portions 62, 72, and 82 of the lens members 60, 70, and 80 can be moved by being pressed with a tool or a finger of an operator via the communication portions 56. Therefore, with the lens unit 40 according to the present embodiment, the lens members 60, 70, and 80 can be easily supported at predetermined positions in the support portion 51 as compared with the case where the communication portions 56 are not formed, and the assembly can be facilitated.

Also, in the present embodiment, the outer peripheral portions 62, 72, and 82 of the three lens members 60, 70, and 80 are exposed from the communication portions 56. Therefore, the relative positions of the three exposed lens members 60, 70, and 80 can be easily set at predetermined positions, and the assembly can further be facilitated.

Further, in the present embodiment, each of the communication portions 56 is a slit extending from the front end toward the rear end of the support portion 51. For example, the tool for gripping the lens members 60, 70, and 80 or the finger of the operator is made to pass through each of the communication portions 56, which is a slit, so that the lens members 60, 70, and 80 can be inserted and moved from the opening 51h1 at the front end into the support portion 51 in a state where the lens members 60, 70, and 80 are gripped. Therefore, with the lens unit 40 according to the present embodiment, the assembly can further be facilitated.

Further, in the present embodiment, the communication portions 56 are formed on both the sides in a predetermined direction with the central axis 51a interposed therebetween, and are formed on both the sides of the side wall of the support portion 51 in the right-left direction perpendicular to the central axis 51a. Therefore, for example, the tool or the finger of the operator is inserted into each of the communication portions 56, so that the lens members 60, 70, and 80 can be pinched, gripped, and moved in the width direction. Therefore, with the lens unit 40 according to the present embodiment, the assembly can further be facilitated.

Further, in the present embodiment, the two communication portions 56 are formed as described above, and the shapes of the lens members 60, 70, and 80 as viewed along the central axis 51a of the support portion 51 are long in the predetermined direction. Also, each of the communication portions 56 exposes the lens members 60, 70, and 80 from the support portion 51. In the case of pinching the lens members in the longer direction, the lens members can be made less likely to be inclined in the thickness direction as compared with the case of pinching the lens members in the shorter direction. Therefore, with the lens unit 40 according to the present embodiment, the lens members 60, 70, and 80 can be easily moved in the support portion 51 as compared with the case where the lens members 60, 70, and 80 are short in length in the predetermined direction.

Further, in the present embodiment, the predetermined uneven pattern is formed on the entire outer peripheral surface of each of the lens members 60, 70, and 80. Therefore, the predetermined uneven patterns in the lens members 60, 70, and 80 are exposed from the communication portions 56. For this reason, the lens members 60, 70, and 80 are easily pinched and gripped in the width direction as compared with the case where no predetermined uneven patterns are formed. Note that, from the viewpoint of easily gripping the lens members, all that is required is that two communication portions 56 are formed in the support portion 51, the outer peripheral surface of at least one of the lens members 60, 70, and 80 has a region where a predetermined uneven pattern is formed, and the region is exposed from the communication portions 56. For example, an uneven pattern may be formed on a part of the outer peripheral surface of the lens member 60, and a region where the uneven pattern is formed may be exposed from each of the communication portions 56.

Further, in the present embodiment, as illustrated in FIG. 4, in a set of the first lens member 60 and the second lens member 70, which is a set of lens members adjacent to each other, the first lens member 60 is provided with the protrusions 65 and 65 as fitting portions, and the second lens member 70 is provided with the hole 77 and the groove 78 as fitting portions. The hole 77 and the one protrusion 65 are fitted to each other, and the groove 78 and the other protrusion 65 are fitted to each other. That is, the pair of the first lens member 60 and the second lens member 70 is provided with fitting portions to be fitted to each other. Therefore, as compared with a case where the hole 77, the groove 78, and the protrusions 65 and 65 are not provided, it is possible to suppress relative positional misalignment between the first lens member 60 and the second lens member 70. In addition, as illustrated in FIG. 8, as viewed along the straight line that perpendicularly intersects with the central axis 51a and passes through the center 56c of the left communication portion 56, the groove 78 and the protrusion 65 fitted in the groove 78 overlap with the left communication portion 56 and are located further on the side provided with the left communication portion 56 than the central axis 51a. Therefore, with the lens unit 40 according to the present embodiment, as viewed in this manner, the groove 78 and the one protrusion 65 can be easily visually recognized through the left communication portion 56 as compared with the case where the groove 78 and the one protrusion 65 do not overlap with the left communication portion 56 or the case where the groove 78 and the one protrusion 65 are located on the opposite side of the side provided with the left communication portion 56 with the central axis 51a interposed between the sides. Therefore, the one protrusion 65 can be easily fitted into the groove 78. In addition, although not illustrated, as viewed along the straight line that perpendicularly intersects with the central axis 51a and passes through the center of the right communication portion 56, the hole 77 and the other protrusion 65 fitted in the hole 77 overlap with the right communication portion 56 and are located on the side provided with the communication portion 56 on the right side of the central axis 51a. Therefore, similarly to the groove 78 and the one protrusion 65, the hole 77 and the other protrusion 65 can be easily visually recognized through the right communication portion 56, and the other protrusion 65 can be easily fitted into the hole 77.

Further, in the present embodiment, as illustrated in FIG. 4, in a set of the second lens member 70 and the third lens member 80, which is a set of lens members adjacent to each other, the second lens member 70 is provided with the protrusions 75 and 75 as fitting portions, and the third lens member 80 is provided with the hole 87 and the slit 88 as fitting portions. The hole 87 and the one protrusion 75 are fitted to each other, and the slit 88 and the other protrusion 75 are fitted to each other. That is, the pair of the second lens member 70 and the third lens member 80 is provided with fitting portions to be fitted to each other. Therefore, as compared with a case where the hole 87, the slit 88, and the protrusions 75 and 75 are not provided, it is possible to suppress relative positional misalignment between the second lens member 70 and the third lens member 80. In addition, as illustrated in FIG. 8, as viewed along the straight line that perpendicularly intersects with the central axis 51a and passes through the center 56c of the left communication portion 56, the slit 88 and the protrusion 75 fitted in the slit 88 overlap with the left communication portion 56 and are located further on the side provided with the left communication portion 56 than the central axis 51a. Therefore, with the lens unit 40 according to the present embodiment, as viewed in this manner, the groove 78 and the one protrusion 65 can be easily visually recognized through the left communication portion 56 as compared with the case where the slit 88 and the one protrusion 75 do not overlap with the left communication portion 56 or the case where the slit 88 and the one protrusion 75 are located on the opposite side of the side provided with the left communication portion 56 with the central axis 51a interposed between the sides. Therefore, the one protrusion 65 can be easily fitted into the groove 78. In addition, although not illustrated, as viewed along the straight line that perpendicularly intersects with the central axis 51a and passes through the center of the right communication portion 56, the hole 87 and the other protrusion 65 fitted in the hole 87 overlap with the right communication portion 56 and are located on the side provided with the communication portion 56 on the right side of the central axis 51a. Therefore, similarly to the slit 88 and the one protrusion 75, the hole 87 and the other protrusion 75 can be easily visually recognized through the right communication portion 56, and the other protrusion 75 can be easily fitted into the hole 87.

Further, in the present embodiment, as illustrated in FIG. 8, the groove 78, the one protrusion 65 fitted in the groove 78, the slit 88, and the one protrusion 75 fitted in the slit 88 are exposed from the left communication portion 56. Therefore, the groove 78, the one protrusion 65, the slit 88, and the one protrusion 75 can be more easily visually recognized and can be easily fitted through the left communication portion 56.

In addition, the lens unit 40 according to the present embodiment further includes the cover 90 having the shielding portions 93 that cover the communication portions 56 from the outside of the support portion 51 in a state of being attached to the support portion 51, and the support portion 51 and the shielding portions 93 have a light shielding property. Therefore, it is possible to restrict a part of the light L emitted from the light source unit 30 and incident on the lens portions 61, 71, and 81 of the lens members 60, 70, and 80 from leaking to the outside of the support portion 51 via the communication portions 56.

Further, in the present embodiment, each of the shielding portions 93 covers the entire edge portion along the edge of the communication portion 56 in the support portion 51. As compared with a case where the shielding portion 93 does not cover this edge portion, it is possible to further restrict a part of the light L from leaking to the outside of the support portion 51. Note that, from the viewpoint of further restricting a part of the light L from leaking, the shielding portion 93 only needs to cover a part of the edge portion along the edge of the communication portion 56 in the support portion 51, and for example, a part of the edge of the shielding portion 93 may be along the edge of the communication portion 56.

Further, in the present embodiment, as illustrated in FIG. 8, as viewed along the straight line that perpendicularly intersects with the central axis 51a and passes through the center 56c of the communication portion 56, outer peripheral edges 62e and 72e on both sides in the thickness direction of the outer peripheral portions 62 and 72 of the lens members 60 and 70 exposed from the communication portion 56 cross the communication portion 56. Therefore, for example, the outer peripheral portions 62 and 72 of the lens members 60 and 70 can be pinched, gripped, and moved in the thickness direction with the tool or the finger of the operator via the communication portion 56. Note that, in the present embodiment, an outer peripheral edge 82e of the outer peripheral portion 82 of the third lens member 80 on the side provided with the second lens member 70 crosses the communication portion 56, and an outer peripheral edge 82e on the other side slightly protrudes from the opening 51h1.

The present invention has been described above by taking the embodiment as an example, and the present invention is not limited to the embodiment.

For example, in the above embodiment, the vehicle lamp 1 is a headlight, but is not particularly limited. For example, the vehicle lamp 1 may be one that irradiates an irradiated object such as a road surface with light constituting an image.

Also, in the above embodiment, the cover 90 having the shielding portions 93 that cover the communication portions 56 from the outside of the support portion 51 in the state of being attached to the support portion 51 has been described as an example. However, the shielding portions 93 may be formed separately from the cover 90 and attached to the support portion 51. Further, the lens unit 40 may not include the shielding portions 93. In this case, a part of the light L emitted from the light source unit 30 and incident on the lens portions 61, 71, and 81 of the lens members 60, 70, and 80 can be emitted from the communication portions 56 to the outside of the lens unit 40, and the aesthetic impression can be improved. From the viewpoint of improving the aesthetic impression by means of light as described above, the shielding portion 93 may be light-transmissive. Furthermore, from this viewpoint, the outer peripheral surface of at least one of the lens members 60, 70, and 80 may have a region where the predetermined uneven pattern is formed, and this region may be exposed from the communication portion 56. In this case, by adjusting the uneven pattern, the emission direction and the diffusion state of the light emitted through the communication portion 56 can be adjusted, and the aesthetic impression can further be improved.

Further, in the above embodiment, the support portion 51 that supports the three lens members 60, 70, and 80 has been described as an example. However, the support portion 51 only needs to support a plurality of lens members, and for example, the support portion 51 may support two lens members.

Further, in the above embodiment, the communication portion 56 that exposes the three lens members 60, 70, and 80 has been described as an example, but the communication portion 56 may expose at least one lens member. In this case, the outer peripheral portion of the lens member exposed from the communication portion 56 can be moved by being pressed with the tool or the finger of the operator. Note that at least two lens members are preferably exposed. With such a configuration, the relative positions of at least two exposed lens members can be easily set at predetermined positions, and the assembly can further be facilitated.

Further, in the above embodiment, the lens unit 40 including the cover 90 has been described as an example, but the lens unit 40 may not include the cover 90. In this case, for example, a member that restricts the third lens member 80 from moving in the direction from the other end side toward the one end side is provided in the support portion 51. An example of this member includes a protrusion that is located further on the side provided with the opening 51h1 than the third lens member 80 in the direction along the central axis 51a and protrudes from the inner peripheral surface of the support portion 51. By doing so, the third lens member 80 can be restricted from coming off of the opening 51h1.

Further, in the above embodiment, the lens members 60, 70, and 80 respectively including the lens portions 61, 71, and 81 and the outer peripheral portions 62, 72, and 82 have been described as examples. However, the lens members 60, 70, and 80 only need to have the lens portions 61, 71, and 81, and may include only the lens portions 61, 71, and 81, for example. In this case, the outer peripheral portions of the lens portions 61, 71, and 81, which are the outer peripheral portions of the lens members 60, 70, and 80, are exposed from the communication portions 56. In addition, the outer peripheral portions 62, 72, and 82 may be intermittently provided in the circumferential direction of the lens portions 61, 71, and 81.

Further, in the above embodiment, the fitting portions fitted to each other in the pair of the first lens member 60 and the second lens member 70 have the configuration of the protrusion 65 and the hole 77 and the configuration of the protrusion 65 and the groove 78. Also, the fitting portions fitted to each other in the pair of the second lens member 70 and the third lens member 80 have the configuration of the protrusion 75 and the hole 87 and the configuration of the protrusion 75 and the slit 88. However, the configuration of the fitting portions fitted to each other is not particularly limited. Also, the lens members 60, 70, and 80 may not have the fitting portions.

According to the present invention, a lens unit and a vehicle lamp that can easily be assembled are provided, and can be used in the field of vehicle lamps for automobiles and the like.

1. A lens unit comprising:
a plurality of lens members each having a lens portion that changes a divergence angle of transmitted light; and
a lens holder including a support portion formed in a cylindrical shape having an opening at one end through which each of the plurality of lens members can be inserted, wherein
the support portion supports the plurality of lens members so as for the plurality of lens members to be arranged along a central axis of the support portion, and
a communication portion that lets an inside and an outside of the support portion communicate with each other and exposes an outer peripheral portion of at least one of the plurality of lens members from the support portion is formed on a side wall of the support portion.

2. The lens unit according to claim 1, wherein
outer peripheral portions of at least two of the lens members are exposed from the communication portion.

3. The lens unit according to claim 2, wherein
a pair of the lens members adjacent to each other out of the at least two of the lens members is provided with fitting portions to be fitted to each other, and
as viewed along a straight line that perpendicularly intersects with the central axis and passes through a center of the communication portion, the fitting portions overlap with the communication portion and are located further on a side provided with the communication portion than the central axis.

4. The lens unit according to claim 1, wherein
the communication portion is a slit extending from the one end toward another end of the support portion.

5. The lens unit according to claim 1, wherein
the lens holder further includes a securing portion that extends from the support portion to a side opposite to a side provided with the central axis and is secured to another member, and a reinforcing plate that extends from the securing portion in a direction non-perpendicular to the central axis and is connected to an outer peripheral surface of the support portion, and
the reinforcing plate overlaps with the communication portion in a circumferential direction of the support portion.

6. The lens unit according to claim 1, wherein
an outer peripheral surface of at least one of the plurality of lens members has a region where a predetermined uneven pattern is formed, and
the region is exposed from the communication portion.

7. The lens unit according to claim 1, wherein
the communication portion is formed on each of both sides in a predetermined direction with the central axis interposed therebetween.

8. The lens unit according to claim 7, wherein
a shape of a specific lens member out of the plurality of lens members as viewed along the central axis is long in the predetermined direction, and
each of the communication portions exposes the specific lens member from the support portion.

9. The lens unit according to claim 1, further comprising:
a shielding portion that covers the communication portion from an outside of the support portion in a state of being attached to the support portion.

10. The lens unit according to claim 9, wherein
the support portion and the shielding portion have a light shielding property.

11. The lens unit according to claim 10, wherein
the shielding portion covers at least a part of an edge portion along an edge of the communication portion in the support portion.

12. A vehicle lamp comprising:
the lens unit according to claim 1; and
a light source unit that emits light transmitted through the plurality of lens members in an arrangement order of the lens members.
